(19) United States
(12) Patent Application Publication
(10) Pub. No.: US 2004/0141797 A1
(43) Pub. Date: Jul. 22, 2004

(54) Advanced aerosol cleaning system

(76) Inventors: Aram Garabedian, Fremont, CA (US); Michael J. Hall, So. San Francisco, CA (US); Carl Kling, San Ramon, CA (US); Robert W. Flagler, Pleasanton, CA (US); Gordon Kapp, Pleasanton, CA (US); Aaron London, Cypress, CA (US); Douglas Walker, Long Beach, CA (US); Dennis Rich, Long Beach, CA (US)

Correspondence Address: THE CLOROX COMPANY, P.O. Box 24305, Oakland, CA, 94623-1305, US

(21) Appl. No.: 10/345,655

(22) Filed: Jan. 16, 2003

(51) Int. Cl. A46B 11/04; A47L 13/22; B05C 17/005; A47L 13/30; A47L 1/08

(52) U.S. Cl. 401/279; 401/278; 401/138; 401/139; 401/190

(57) ABSTRACT

An advanced cleaning system comprising cleaning compositions, pads, and implements provide effective cleaning of soft and hard surfaces. The implement comprises a handle portion (14) with a proximal end and a distal end, a cleaning head portion (12), the cleaning head portion (12) adapted for use with a removable cleaning pad (40), and an aerosol cleaner (24) coupled to the cleaning head portion (12) such that cleaning fluid is applied adjacent the cleaning head portion (12).

### FIELD OF THE INVENTION

The present invention relates to cleaning compositions, pads, and implements useful in removing soils from soft and hard surfaces. The compositions are preferably foaming cleaners and treatments.

The cleaning pads are designed to pick up soils and stains upon hard and soft surfaces, to leave beneficial, aesthetic and/or functional residues and to be reusable or conveniently disposable.

The cleaning implement comprises a handle, an aerosol delivery device, a cleaning head and a disposable pad attached to the cleaning head.

### BACKGROUND OF THE INVENTION

Cleaning devices and systems for use in the home, industrially or otherwise include a broad range if technology. With regard to hand-held, mop-like devices used by an individual, the prior art is replete with variations. Conventional floor, ceiling, wall or other surface mops typically have a rigid, elongated handle portion, the handle having a proximal and a distal end. The handle portion is held closer to the proximal end, while a cleaning head is placed at the distal end of the handle.

Recently, lightweight, hand-held mops with on-board liquid delivery systems and disposable cleaning pads have been developed. WO 01/72195 to Hall et al. describes a mechanical, gravity-fed mop system that provides consumer convenience. This mop system depends upon designs using a low pressure, liquid deliver system. US20010046407 describes a electrical pump fed mop system. This mop system depends upon batteries and a complex and expensive pump system to deliver the cleaning composition. It would be desirable to have a simple, mechanical system that could deliver the cleaning composition under pressure. It would also be desirable to have a simple mechanical system that would work on both hard and soft surfaces, including carpets, and would be light enough to use not only on floors, but also on vertical and raised surfaces around the house.

Aerosol carpet cleaners are well known. Generally, the aerosol is scrubbed into the carpet or allowed to dry on the carpet and then vacuumed. For example, U.S. Pat No. 5,928,384 to Scialla and Raso describes a typical procedure. The step of applying a composition for the cleaning of carpets may be followed by a rubbing step or/and a brushing step by means of a sponge or a brush or other mechanical/electrical device, optionally with the aid of water. In general, the rubbing/brushing-times are between 0.1 to a few minutes per square meters. The composition is then removed from the carpet, preferably by mechanical means including brushing out or/and vacuum cleaning. This procedure requires several tools and, therefore, progress in cleaning is slowed by finding, carrying and using these tools.

U.S. Pat No. 4,969,854 to Katsuda et al. describes an applicator that attaches to an aerosol can in order to apply an insecticide directly to carpets through an absorbent strip running along the outside of the can. U.S. Pat. No. 3,679,319 to Munchel and Thornton describes spray device for overhead surfaces having a pole with a U-shaped aerosol holder and optional dusting mop attachment. U.S. Pat. No. 3,490,650 to Mahwah and Neal describes a rechargeable, pressurized, elongated plastic tube that delivers a cleaning composition to a mop head. U.S. Pat. No. 4,432,472 to Lamm describes an optional aerosol attachment to a floor-buffing machine. U.S. Pat. No. 4,249,280 to Goodrich describes a vacuum cleaner bag pocket, which can carry an aerosol carpet cleaner. U.S. Pat. No. 3,979,163 to Beard describes a scrub head attachment to an aerosol can. None of these inventions describe a simple mopping device incorporating an aerosol can.

### SUMMARY OF THE INVENTION

The present invention relates to cleaning compositions,pads, and implements useful in removing soils from soft and hard surfaces. The compositions are preferably foaming cleaners and treatments. The cleaning implement comprises a handle, an aerosol delivery device, a cleaning head and a disposable pad attached to the cleaning head.

### BRIEF DESCRIPTION OF THE DRAWINGS

FIG. 1 is a left side view of one embodiment of the inventive cleaning implement.

FIG. 2 is a partial exploded view of the handle of one embodiment of the inventive cleaning implement.

FIG. 3 is a perspective view of one embodiment of the inventive cleaning implement.

FIG. 4 is an exploded view of the head assembly and a disposable cleaning pad of one embodiment of the inventive cleaning implement.

FIG. 5 is a perspective view of one further embodiment of the inventive cleaning implement, emphasizing a secondary hand grip.

FIG. 6 is a right side view of one embodiment of the inventive cleaning implement.

FIG. 7A is a top plan view of the head assembly of one embodiment of the inventive cleaning implement.

FIG. 7B is a front view of the head assembly of FIG. 7A.

FIG. 7C is a bottom plan view of the head assembly of FIG. 7A.

FIG. 8A is a top plan view of canister overcap of one embodiment of the inventive cleaning implement.

FIG. 8B is a bottom plan view of the canister overcap of FIG. 8A.

FIG. 8C is a top perspective view of the canister overcap of FIG. 8A.

FIG. 8D is a bottom perspective view of the canister overcap of FIG. 8C.

FIG. 8E is a side view of the canister overcap of FIG. 8A.

FIG. 9A is a partial exploded view from the left depicting the canister loaded into the loading holster of one embodiment of the inventive cleaning implement.

FIG. 9B is a partial exploded view from the front depicting the embodiment of the inventive cleaning implement of FIG. 9A.

FIG. 10 depicts one embodiment of the inventive cleaning implement, with a male figure added in silhouette to depict relative scale.

FIG. 11 depicts one embodiment of the inventive cleaning implement, with a female figure added in silhouette to depict relative scale.

FIG. 12A depicts one embodiment of a scrubbing rake used with the inventive cleaning implement.

FIG. 12B depicts a further embodiment of a scrubbing rake used with the inventive cleaning implement.

FIG. 12C depicts another embodiment of a scrubbing rake used with the inventive cleaning implement.

FIG. 12D depicts yet another embodiment of a scrubbing rake used with the inventive cleaning implement.

FIG. 13 depicts one means of attachment for the rake.

FIG. 14 depicts another means of attachment for the rake.

### DETAILED DESCRIPTION OF THE INVENTION

Cleaning Implement

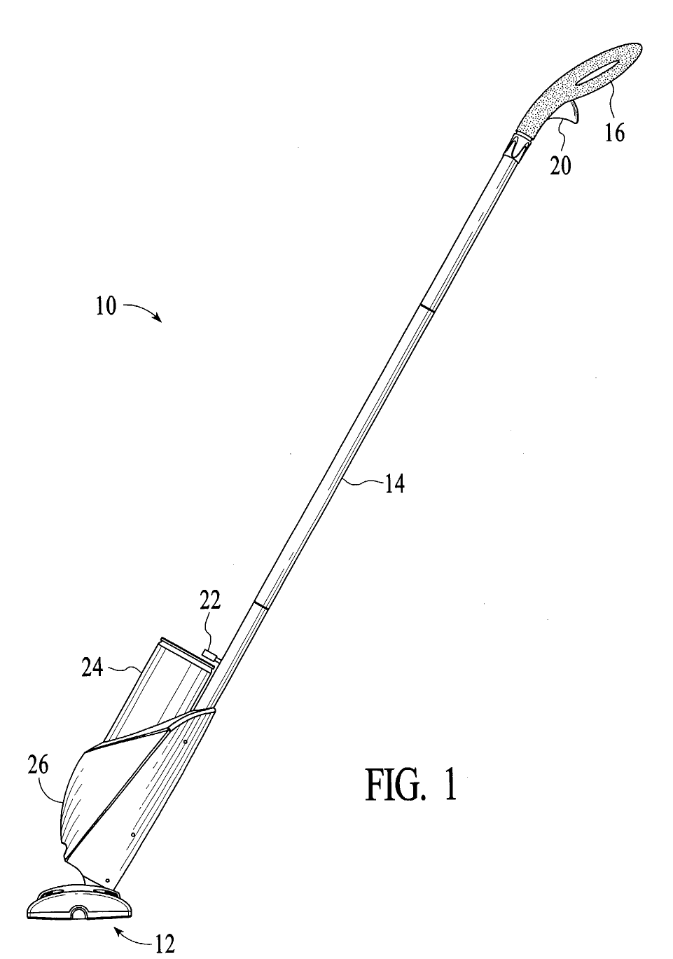

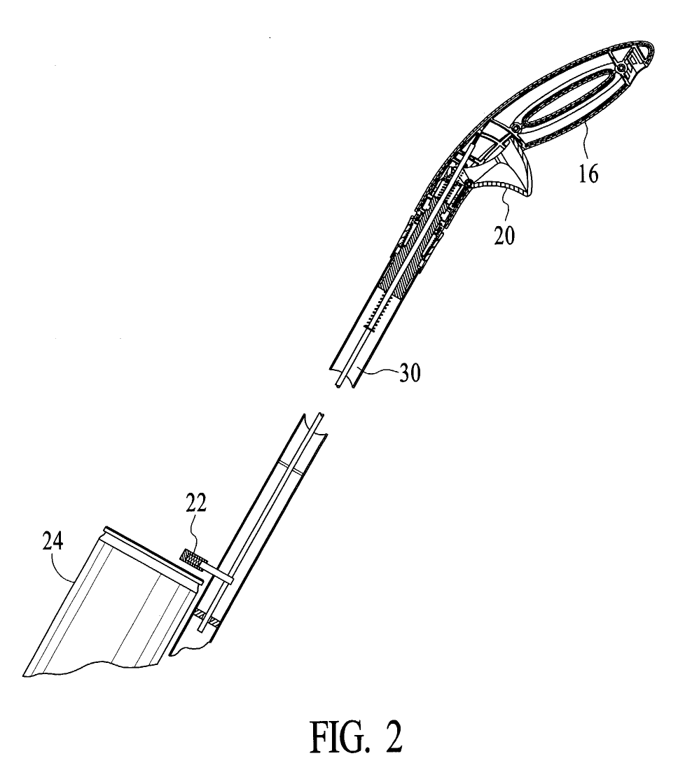

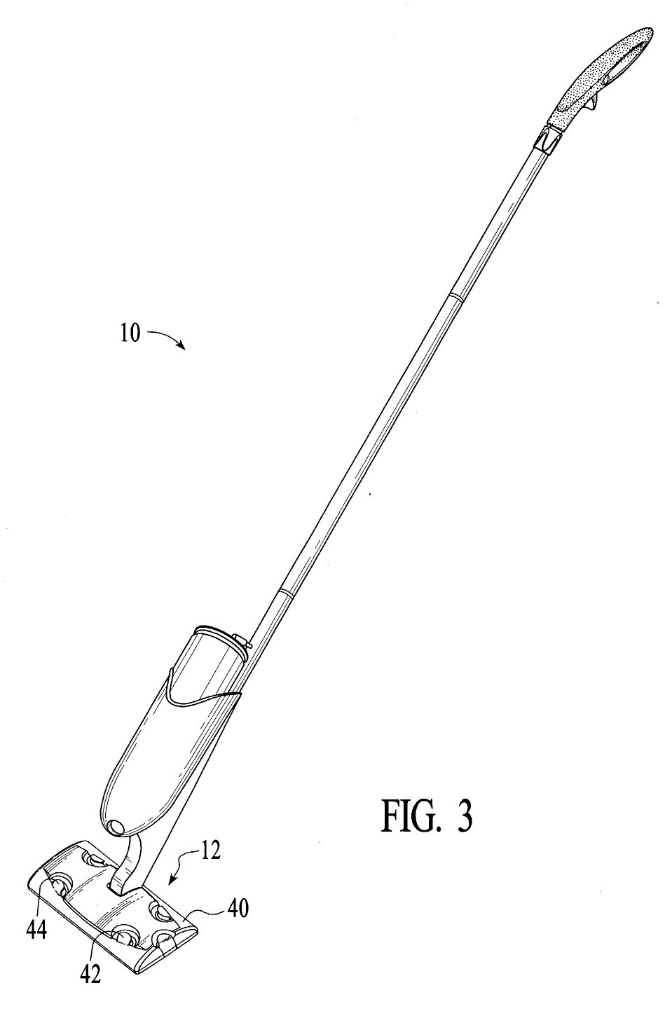

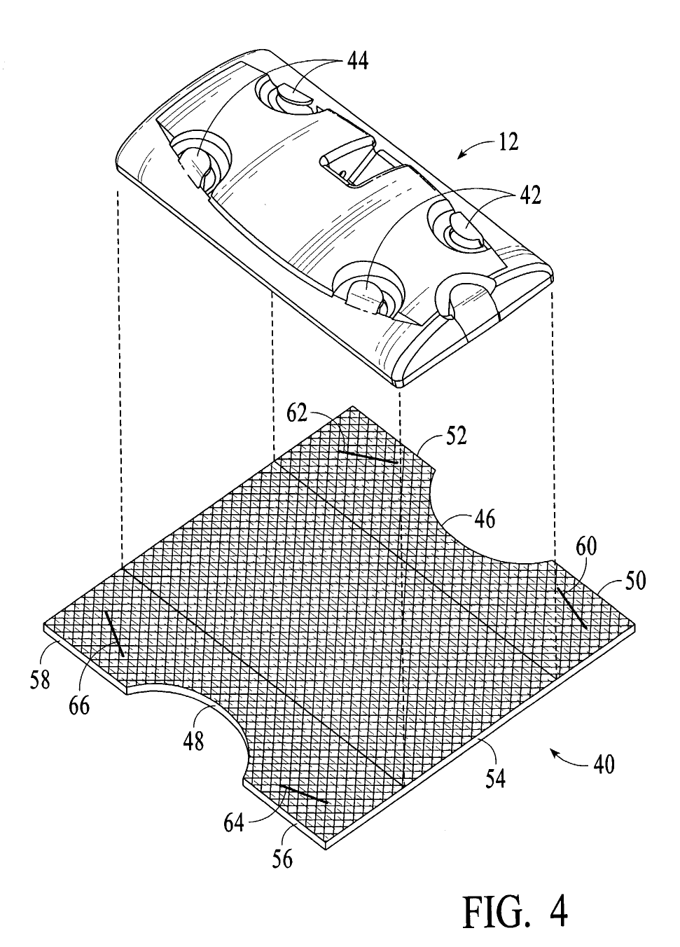

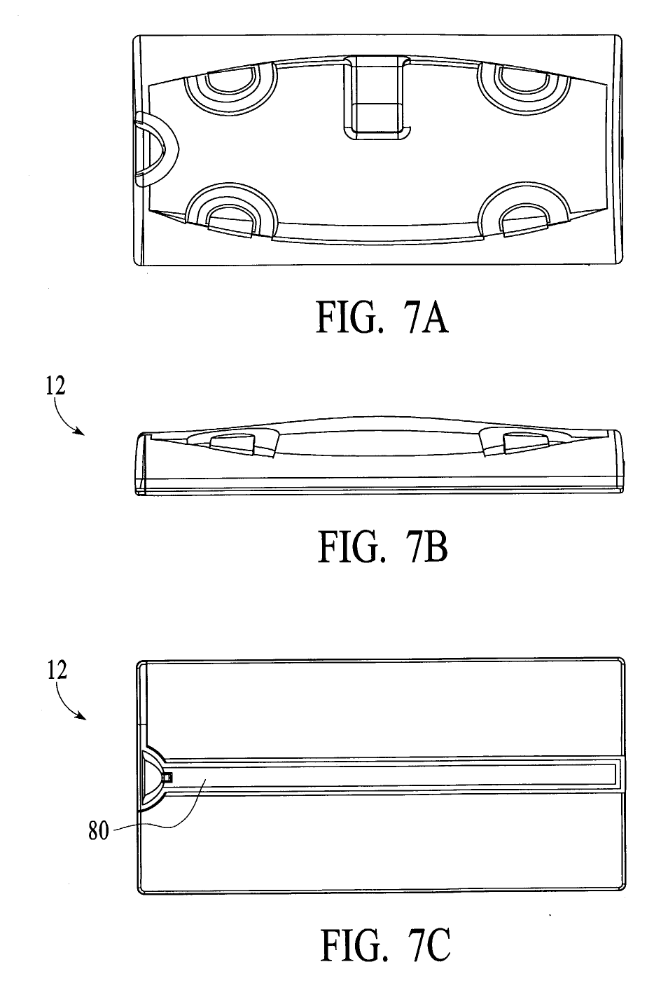

The cleaning implement comprises a handle, an aerosol delivery device, a cleaning head and a disposable pad attached to the cleaning head. The cleaning head comprises numerous parts and is referred to as a cleaning head assembly herein. FIG. 1 depicts an orthogonal view of the invention. The cleaning implement is generally depicted as 10, with a cleaning head assembly 12, a pole (here, depicted as multi-piece) 14, a handle which may or may not include an aperture in the gripping surface, a trigger 20, which is connected to an actuator rod 22, the aerosol canister 24, which is seated in a holster 26. Turning now to FIG. 2, a partial exploded view of the handle 14, depicts the mechanism in greater detail. The trigger 20 is connected via rod 30 to actuator 22, which exerts a downward force on canister 24 in order to expel with control the pressurized contents of canister 24. FIG. 3 is a perspective view of the invention, with the cleaning head assembly 10, and a more detailed view of the cleaning head assembly 12. Cleaning pad 40 is partially shown, with portions thereof affixed, tucked or looped into stays 44 and 42. FIG. 4 shows in yet further detail the cleaning head assembly 12 and the cleaning pad 40. Assembly 12 is provided on its upper surface with stays 42, 42 and 44, 44. Cleaning pad 40, whose material is described in further detail herein below, is generally a non-woven material which can be textured to enhance its abrasive cleaning action. Pad 40 is provided with notches 46 and 48, to allow non-interfering access by the canister fluid. Wings 50, 52, 56 and 58 define the outer edges of pad 40. To hold fast these wings to the cleaning head assembly 12, slits 60, 62, 64 and 66 are slotted to correspond to the stays 42, 42 and 44, 44. Turning now to FIGS. 7A-7C, different views of the cleaning head assembly are provided. FIG. 7A provides a top, plan view of one embodiment of the cleaning head assembly 12. FIG. 7B is a front view of the head assembly 12. FIG. 7C is a bottom elevational view of the head assembly 12. In particular, the bottom face or plate of assembly 12 is provided with a groove or channel 80, into which will nest a holdfast for the cleaning pad 40, or, more preferably, a rake or other abradent tool.

Handle

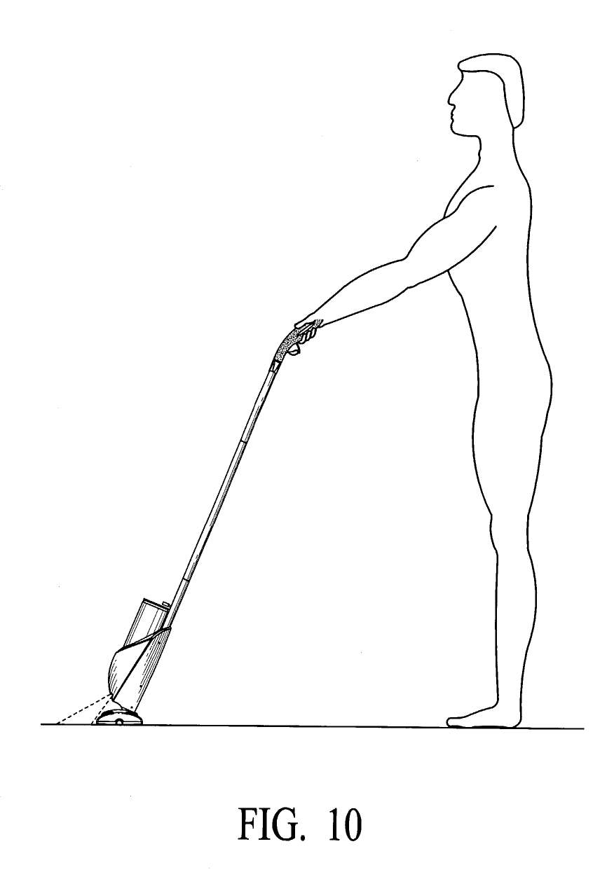

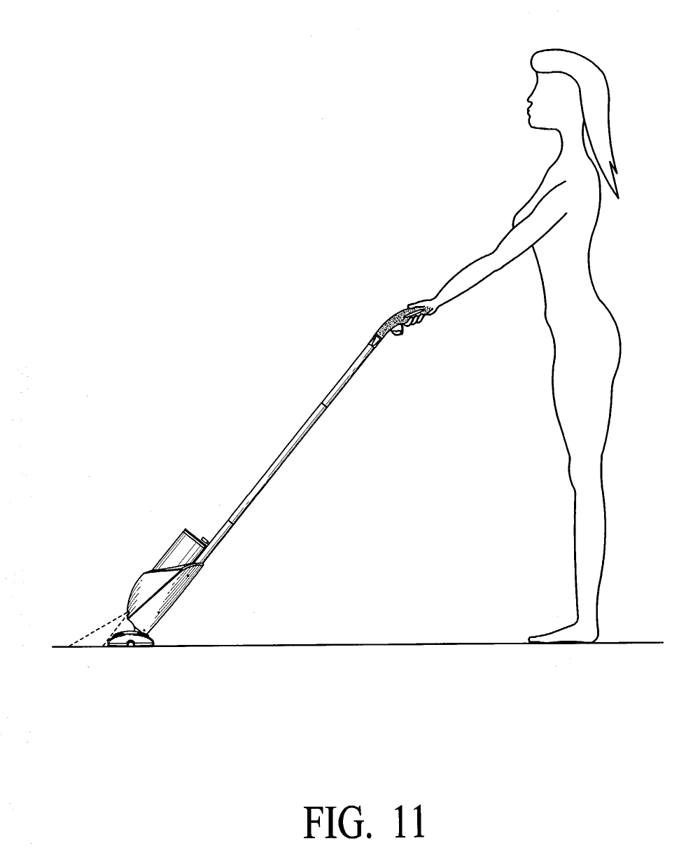

The handle is preferably a light metal (such as, without limitation, aluminum); plastic, wood or other lightweight material, which functions as a gripping surface for the user. The handle can be provided with or without an aperture, preferably oblong, and a trigger or other actuating mechanism for actuating the canister. In addition, the handle is defined by a longitudinal pole having a proximal and a distal end. The length of the pole and handle is such that the user will actuate the cleaning system in an upright position. FIGS. 10 and 11 show the silhouettes of male and female users using the invention in upright positions.

Handle Trigger Guard

An optional handle trigger guard is integrated into handle to prevent accidental discharge of the aerosol if the handle and pole are dropped.

Pole

The pole is connected to the mop head by means of a universal or swivel joint. The pole is preferably hollow and collapsible in order to present a compact form for shipping and display purposes. The pole may be threaded, friction-fit, or some other type of engagement that allows for sturdy reassembly. Preferably, the pole is fitted with a bayonet for ease of correct alignment and assembly.

Secondary Handle Grip

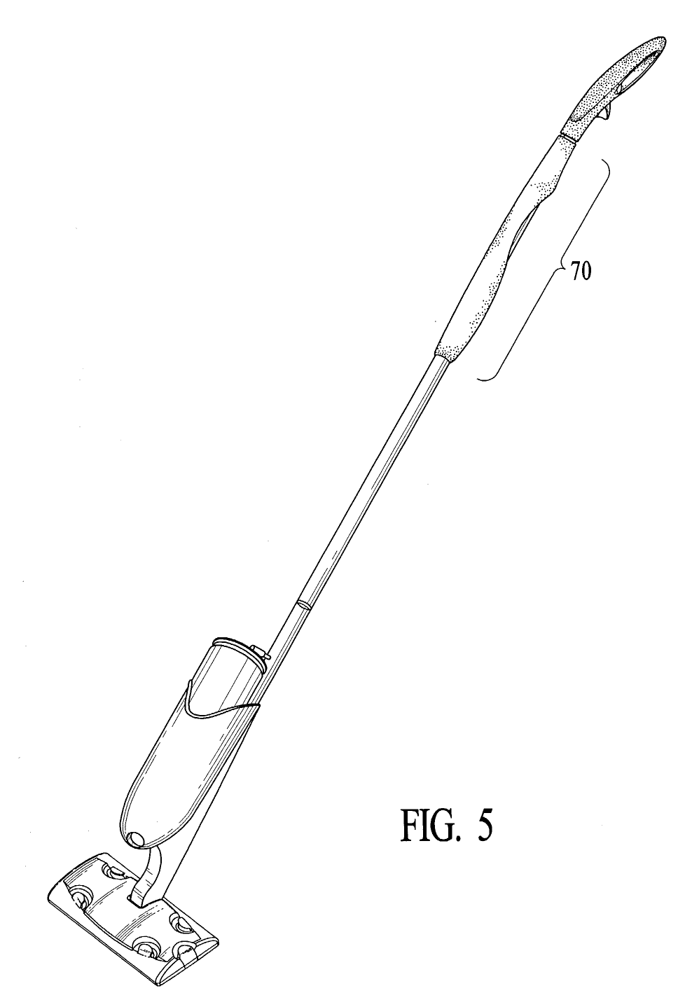

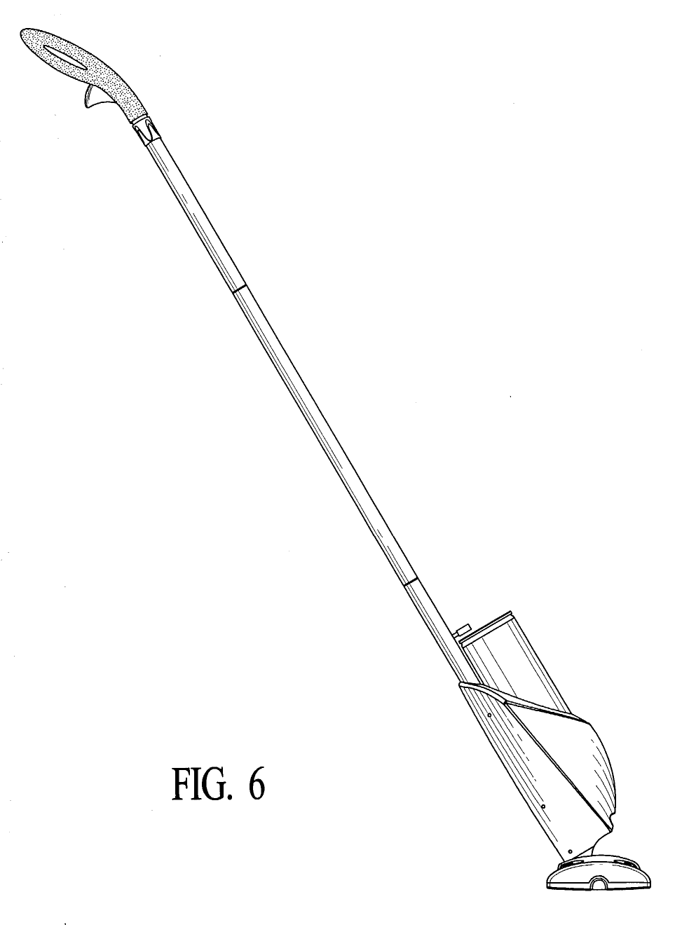

A secondary handle grip orients consumer hand to provide additional leverage for easier scrubbing. The secondary handgrip preferably is 4 to 8 inches (10 to 20 cms) long and has a diameter of about one inch (2.5 cms) larger than the pole diameter for greater ergonomic efficiency. FIG. 5 shows yet another perspective view of an embodiment of the invention, with reference character 70 depicting the secondary handle grip. Because of the orientation of the handle, either a right- or left-handed primary grip can be achieved, with the corresponding other hand to provide the second handle grip for maximum stability.

Aerosol Can Cradle

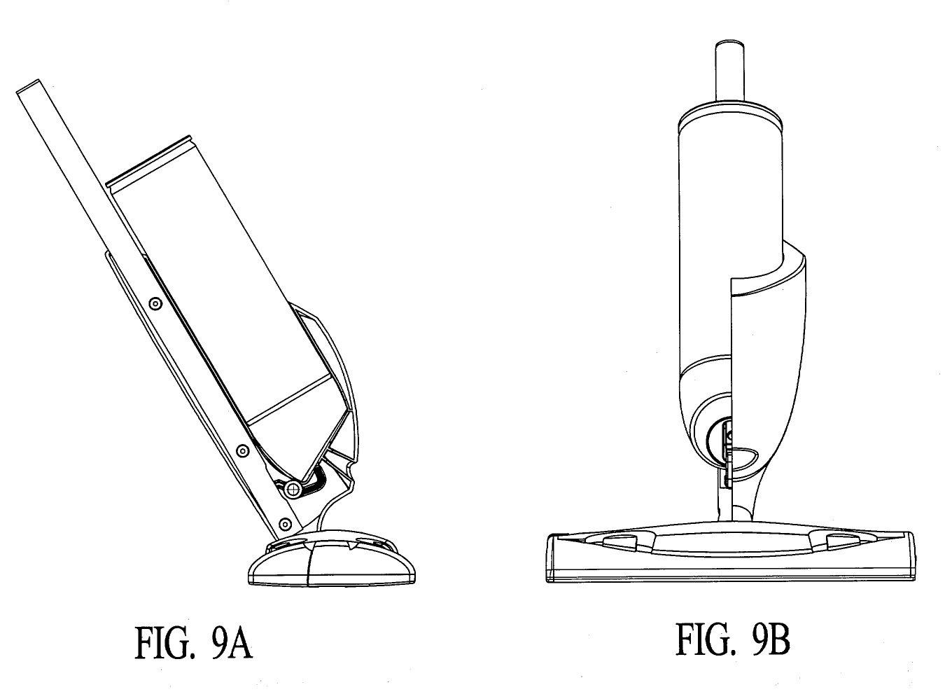

The aerosol can cradle is attached to the pole on the front or backside. More preferably, the cradle is an integral extension of the pole, with the can and pole about on the same centerline, so that consumers will have a good line of sight to the cleaning surface. The cradle is primarily depicted in FIGS. 9A and 9B.

Aerosol Can

Additionally, WO9804666 to Ochomogo describes an optimal aerosol delivery system. The cleaning composition is preferably stored in and dispensed from a pressurized can that is equipped with a nozzle so that an aerosol of the composition can be readily sprayed onto a carpet surface to create a relatively uniform layer of foam. A preferred nozzle comprises a vertical valve having a rectangular orifice with dimensions of 0.0 10 in.×0.031 in. that is manufactured by Summit Packaging System, Inc., Manchester, N.H. Dispensers are known in the art and are described, for example, in U.S. Pat. Nos. 4,780,100, 4,652,389, and 3,541,581 which are incorporated herein. Although pressure within the dispenser does not appear to be critical, a preferred range is about 40 to 58 tbs./in, more preferably 40 to 50 lbs./in 2, and most preferably 40 to 47 lbs./in 2 at 70° F. (21° C.).

Said aerosol dispensers comprise a container which can be constructed of any of the conventional materials employed in fabricating aerosol containers. The dispenser must be capable of withstanding internal pressure in the range of from about 20 to about 110 p.s.i.g., more preferably from about 20 to about 70 p.s.i.g. The one important requirement concerning the dispenser is that it be provided with a valve member which will permit the carpet cleaning composition contained in the dispenser to be dispensed in the form of a spray of very fine, or finely divided, particles or droplets, which is defined as “foam,” as set forth hereinbefore. See also, D. J. Durian, “Foams,” Kirk-Othmer Encyclopedia of Chemical Technology (1994). The aerosol dispenser utilizes a pressurized sealed container from which the aqueous composition is dispensed through a special actuator/valve assembly under pressure. The aerosol dispenser is pressurized by incorporating therein a gaseous component generally known as a propellant. Common aerosol propellants, e.g., gaseous hydrocarbons such as isobutane, and mixed halogenated hydrocarbons, can be used. Halogenated hydrocarbon propellants such as chlorofluoro hydrocarbons have been alleged to contribute to environmental problems, and are not preferred. When cyclodextrin is present in the carpet cleaning composition for odor control reasons, hydrocarbon propellants are not preferred, because they can form complexes with the cyclodextrin molecules thereby reducing the availability of uncomplexed cyclodextrin molecules for odor absorption. Preferred propellants are compressed air, nitrogen, inert gases, carbon dioxide, etc. A more complete description of commercially available aerosol-spray dispensers appears in U.S. Pat. No. 3,436,772, Stebbins, issued Apr. 8, 1969; and U.S. Pat. No. 3,600,325, Kaufman et al., issued Aug. 17, 1971; both of said references are incorporated herein by reference. Preferably the spray dispenser can be a self-pressurized non-aerosol container having a convoluted liner and an elastomeric sleeve. Said self-pressurized dispenser comprises a liner/sleeve assembly containing a thin, flexible radially expandable convoluted plastic liner of from about 0.010 to about 0.020 inch (i.e. from about 0.025 to 0.051 cm) thick, inside an essentially cylindrical elastomeric sleeve. The liner/sleeve is capable of holding a substantial quantity of carpet cleaning composition product and of causing said product to be dispensed. A more complete description of self-pressurized spray dispensers can be found in U.S. Pat. No. 5,111,971, Winer, issued May 12, 1992, and U.S. Pat. No. 5,232,126, Winer, issued Aug. 3, 1993; both of said references are herein incorporated by reference. Another type of aerosol spray dispenser is one wherein a barrier separates the carpet cleaning composition from the propellant (preferably compressed air or nitrogen), as disclosed in U.S. Pat. No. 4,260,110, issued Apr. 7, 1981, and incorporated herein by reference. Such a dispenser is available from EP Spray Systems, East Hanover, N.J.

Aerosol Can Connection

A standard aerosol can is preferably locked into a cradle by means of a latch mechanism. The latch mechanism preferably operates less than 10 lbs. of force.

The cradle preferably orients the aerosol can or aerosol actuator such that the can easily orients itself in a particular operational direction. Preferably, the aerosol actuator or nozzle is within the sight lines of the operator so the liquid or foam cleaner is easily controllable. The liquid or foam cleaner is dispensed in a reverse conical pattern, the liquid or foam cleaner being emitted from the actuator in a thin stream, which then broadens as the stream leaves the orifice. The following references can be utilized in the design of the aerosol canister and its nozzle or similar actuator: U.S. Pat. No. 5,915,598 Flow controller for aerosol container; U.S. Pat. No. 5,503,303 Dual function self-pressurized aerosol actuator overcap; U.S. Pat. No. 3,967,763 Clip mounted aerosol dispenser actuator.

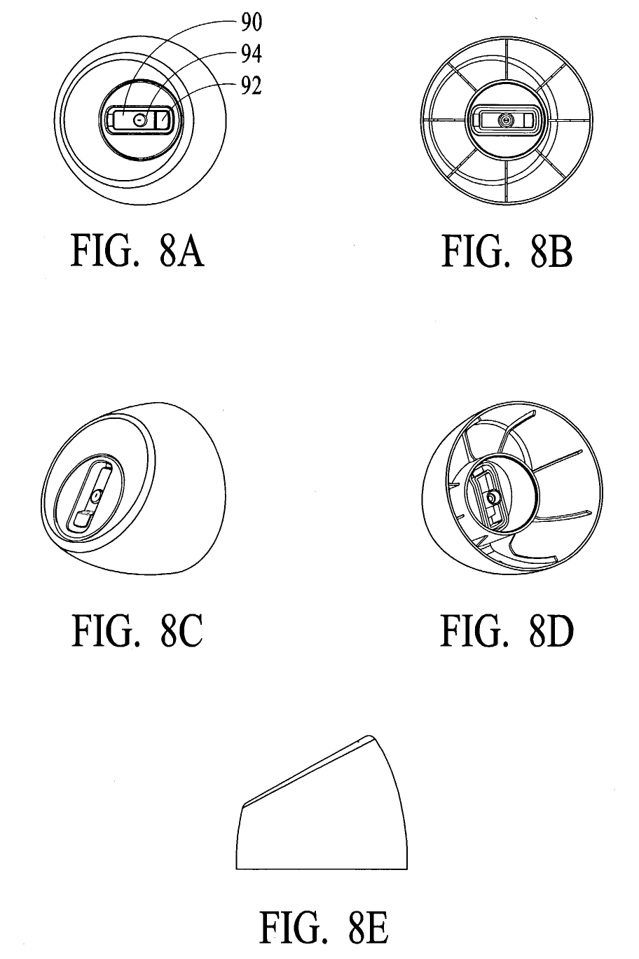

FIGS. 8A through 8E depict various embodiments of the cap which is also an aerosol actuator. With reference to FIG. 8A, a hinged portion 90 will actuate nozzle 94. Generally, this is caused by depressing trigger 20, which is attached via rod 30 to actuator 22.

Aerosol Actuator

The aerosol actuator is preferably oriented relative to the front and back of the mop head. This can be accomplished by a key or orientation mechanism in the cradle, which orientates the actuator as the aerosol can is inserted or the cradle can orientate the aerosol cap if the actuator is built into the cap.

If the aerosol can actuator is oriented relative to the mop, the aerosol actuator orifice is preferably tilted at an angle of 5 to 15 degrees relative to the vertical centerline of the can.

If the aerosol can actuator is oriented relative to the mop, then a fan shaped spray is preferred. The preferred angle of the spray is 45 to 90 degrees, more preferably 60 to 80 degrees.

The aerosol actuator orifice is preferably elevated from the actuator to prevent foam build-up.

If the aerosol actuator is not oriented, then a circular spray pattern is preferred. The circular spray pattern is preferably defined by a cone of less than 12 inches (30 cms).

If the aerosol actuator is not oriented, then the orifice can be connected via a flexible tube to the aerosol nozzle tube. In this way, the orifice will be orientated and a fan shaped spray is preferred. The preferred angle of the spray is 45 to 90 degrees, more preferably 60 to 80 degrees. If the orifice is attached to the pole, then the aerosol actuator orifice is preferably tilted at an angle of 5 to 15 degrees relative to the pole.

This invention includes an actuator assembly, for an aerosol valve, with a rotatable or movable secondary actuator mechanism for changing the spray pattern of a fluid being dispensed from an aerosol valve and, more particularly, to a secondary actuator mechanism having at least two distinct spray dispensing positions. Another reference of interest is JP54042855 NOZZLE OF WASHING CARPET, incorporated herein by reference.

Pole Attachment

The pole is preferably attached to the mop head with a swivel joint or universal joint. The joint is preferably within 1 to 1½ inches (2.5-3.75 cms) from the bottom of the mop so that the consumer can provide maximum leverage to the scrubbing task.

Pad Attachment

The pad can be attached to the mop with adhesive, or can be fitted into narrow openings, such as, without limitation, star-shaped slits and tucked into said slits, which are preferably mounted on the upper surface of the mop head assembly.

Preferably, the pad has slits at the four corners to fit over hooks in the mop head. This is an economical way to provide maximum security to the pad attachment.

Pad

The pad, or cleaning cloth, preferably is textured to provide an abrasive surface, useful for scrubbing. Further, at least a portion of the pad is made to “glide” that is, reduce surface friction. In other areas, the potential surface area could be reduced, or a laminated netting could be overlaid or stamped or embossed onto the pad surface. Optionally, wheels on the mop head assembly, which would contact the surface on which the assembly is placed and would penetrate the pad through apertures therein, would reduce force on carpet or other surface.

The pad should be durable yet disposable.

A raised surface (adjustable) to lower resistance could preferably applied to the pad. Additionally, the pad can incorporate materials to break foam (antifoam additives). Further, the pad itself could have features that generate foam, in addition to the abrasive surface it preferably provides.

Scrubbing Rake

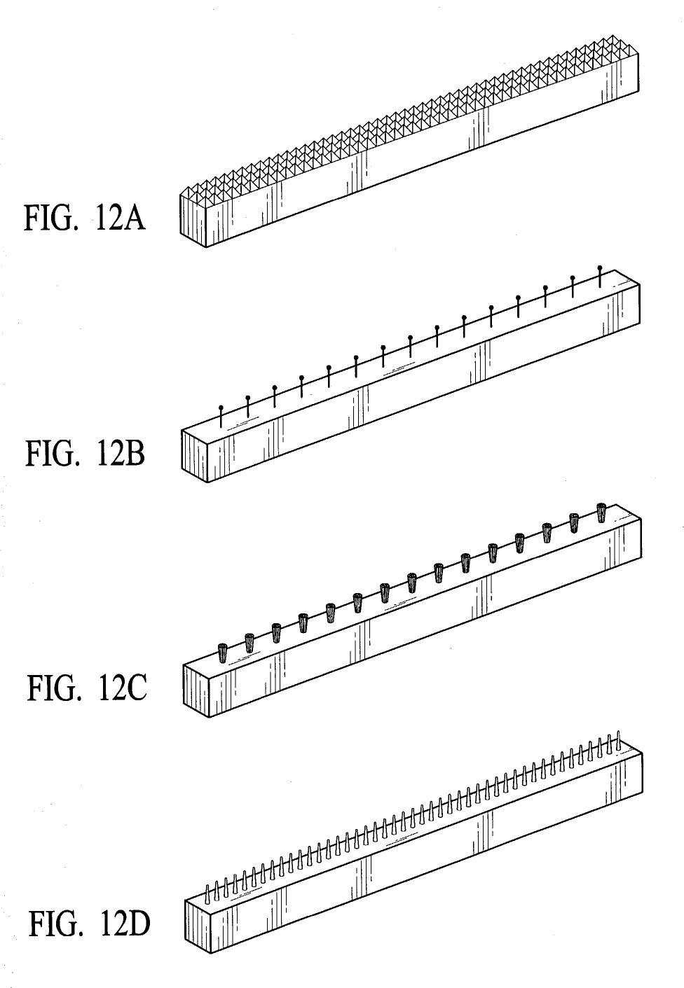

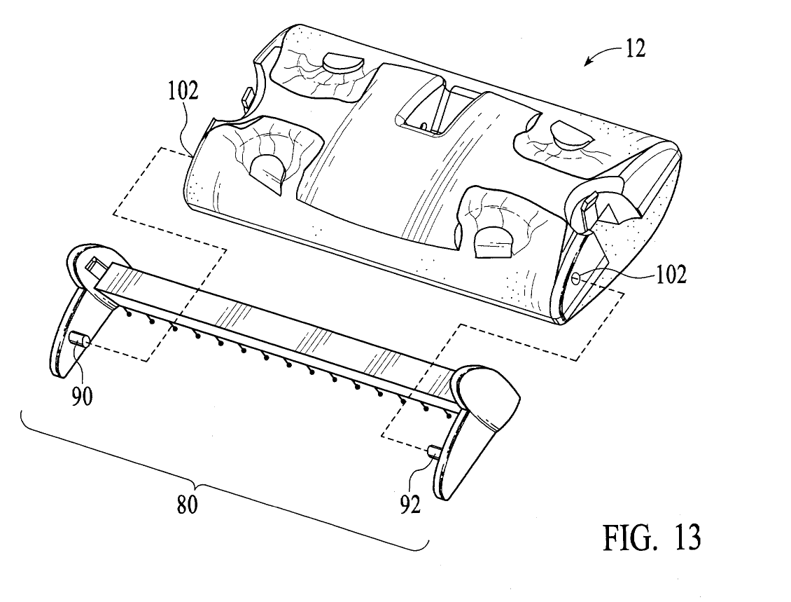

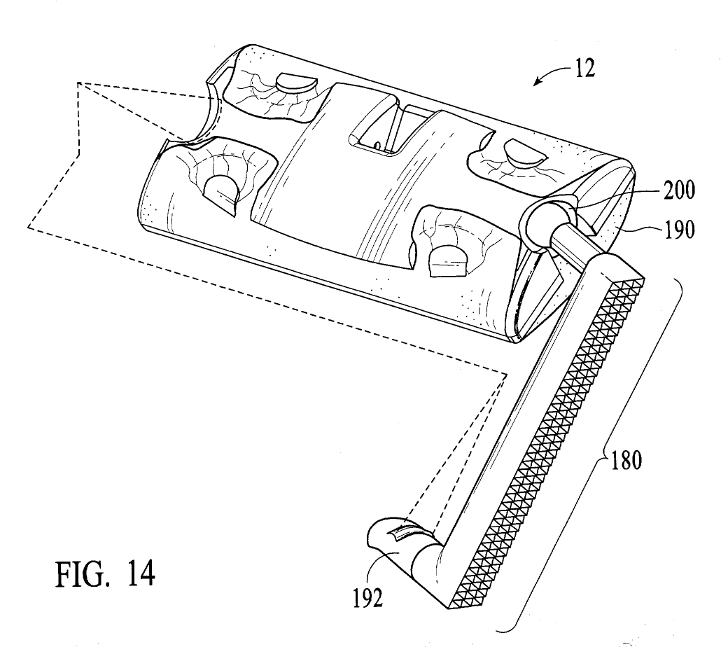

In yet another embodiment, a flexible comb could be added as an additional abrasive and/or foam-generating surface. Attaching the rake to the mop head assembly requires careful consideration. First, it should be centered on width on the bottom of the mop. It is preferably a flexible brush attachment, which causes minimal damage to carpet or other flooring surfaces. The rake can help foam penetrate into soft surfaces. Turning now to FIGS. 12A-12D, four different embodiments of the scrubbing rake are provided. FIG. 12A depicts a bottom scrubbing surface which are beveled surfaces or quadrihedrons. FIG. 12B shows rounded comb heads mounted on posts. FIG. 12C depicts more stout brushes. FIG. 12D depicts sharper comb surfaces. Naturally, other surfaces can function as the rake's abrasive surfaces. In FIG. 13, a rake provided with comb surfaces, articulates knobs or posts 90, 92 with corresponding apertures 100, 102, to provide a tight, friction fit. The rake also functions to an extent as a means for holding down the pad surface contacting the floor or carpet or other horizontal or vertical surface to which the pad is applied. FIG. 14 shows an alternative embodiment, in which rake 180 is hinged from socket 200 via ball joint 190, with arm 192 providing a similar function. In this embodiment, at least of arm 192 or joint 190 can be completely dislodged from its socket or holding means, so that a pad can be changed. Further, rounded portions such as glides can be incorporated on the rake itself to reduce friction as the tool passes over various surfaces, such as carpets. The brush can be designed to improve glide as well. As previously mentioned, glides could be provided, instead of or in addition to, texture surfaces on the pad.

Cleaning Composition

Foam

In normal aerosol carpet cleaning, the foam is very stable for at least 5 to 10 minutes. Because this mop is designed to clean large areas easily, it is preferred that the foam be visible and consumer noticeable, however, it should be easily dispersed. The preferred foam of the invention is stable for only 1 to 2 minutes.

Water and Miscellaneous

Since the composition is an aqueous composition, water can be, along with the solvent, be a predominant ingredient. The water should be present at a level of less than 99.9%, more preferably less than about 99%, and most preferably, less than about 98%. Deionized water is preferred.

Small amounts of adjuncts can be added for improving performance, stability or aesthetic qualities of the composition. For example, buffers can be added to maintain a constant pH (which for the invention is between about 5-14, more preferably between about 8-13; formulations containing the tripotassium and/or triammonium salts will naturally be at a lower end of the range as compared to the corresponding tetra salts). These buffers include, for example, NaOH, KOH, Na₂CO₃, and K₂CO₃ as alkaline buffers, and phosphoric, hydrochloric, sulfuric, and citric acids as acidic buffers, among others. It may be desirable to add chelating agents, such as polycarboxylates (e.g., EDTA and its alkali metal and ammonium salts), aminopolyphosphonates and polyphosphonates, metasilicates and organic amines. Chelating agents may help to potentiate antimicrobial efficacy or have other functional uses.

Further solubilizing materials, such as hydrotropes (e.g., water soluble salts of low molecular weight organic acids such as the sodium or potassium salts of cumene-, toluene-, benzene-, and xylene sulfonic acid), may also be desirable. Adjuncts for cleaning include additional surfactants, such as those described in Kirk-Othmer, Encyclopedia of Chemical Technology, 3rd Ed., Volume 22, pp. 332-432 (Marcel-Dekker, 1983), and McCutcheon's Soaps and Detergents (N. Amer. 1984), which are incorporated herein by reference. Aesthetic adjuncts include fragrances or perfumes, such as those available from Givaudan, IFF, Quest, Sozio, Firmenich, Dragoco and others, and dyes or colorants which can be solubilized or suspended in the formulation, such as diaminoanthraquinones. Water-insoluble solvents may sometimes be desirable as added grease- or oily soil-cutting agents. These types of solvents include tertiary alcohols, hydrocarbons (e.g., alkanes), pine-oil, d-limonene and other terpenes and terpene derivatives, and benzyl alcohols. Thickeners, such as calcium carbonate, sodium bicarbonate, aluminum oxide, and polymers, such as polyacrylate, starch, xanthan gum, alginates, guar gum, cellulose, and the like, may be desired additives, although care must be taken since the inventive compositions are meant to be relatively thin liquids for effective dispensation from a pressurized canister. The use of some of these thickeners (e.g., CaCO₃ or NaHCO₃) is to be distinguished from their potential use as builders, generally by particle size or amount used. Additional additives may include antimicrobial compounds, such as phenols (See, Moseman, U.S. Pat. No. 4,985,945, incorporated herein by reference), pine oil (See Spaulding et al., U.S. Pat. No. 4,867,898, incorporated herein by reference) and liposome-like micro emulsions such as mentioned in the paper by T. Hamouda et al., “Microbiocidal Effects of Liposomes-Like Microemulsions on Pathogenic Gram Negative Bacteria,” in: Poster Session 251/A Antimicrobial Therapy and Charactertization of Pathogens, American Society of Microbiology 98th Annual Meeting, May 17-21, 1998, p. 152, said paper incorporated herein by reference. Other, preferred antimicrobial, antifungal or antiallergen materials can be added, for example, when using the invention to clean carpets or other soft surfaces which can be inoculated or impregnated with disease-causing, odor-causing or allergens by the mere treading of the surface. These antimicrobial, antifungal or antiallergen materials include water-soluble, film-forming polymers (See, Ochomogo et al., U.S. Pat. No. 6,454,876, incorporated herein by reference), quaternary ammonium compounds and complexes therewith (See Zhou et al., U.S. Pat. Nos. 6,482,392, 6,080,387, 6,284,723, 6,270,754, 6,017,561 and 6,013,615, all of which are incorporated herein by reference), essential oils, such as nerolidol (See Shaheen et al, U.S. Pat. No. 6,361,787, incorporated by reference), Kathon (See, Sells et al., U.S. Pat. No. 5,789,364 and Koerner et al., U.S. Pat. No. 5,589,448 incorporated by reference), and, possibly, bleaches, such as hydrogen peroxide and alkali metal hypochlorite.1 As already noted above, the preferred container for dispensing of the present composition in aerosol form is a tin-plated steel can, but other aerosol packages may be suitable for use. Therefore, it is advantageous to add one or more corrosion inhibitors to prevent or at least reduce the rate of expected corrosion of such a metallic dispenser. Chloride salts, if present, may cause corrosion. Preferred corrosion inhibitors include, for example, sodium nitrite, potassium nitrite, sodium benzoate, potassium benzoate, amine neutralized alkyl acid phosphates and nitroalkanes, amine neutralized alkyl acid phosphates and volatile amines, diethanolamides, amine borates, hydroxylamines, alkanolamines, amine carboxylates, esters, volatile silicones, amines and mixtures thereof. Specific inhibitors include, for example, sodium lauroyl sarcosinate, available from Stepan Company under the trademark Maprosyl 30, sodium meta silicate, sodium or potassium benzoate, triethanolamine, and morpholine. When employed, the corrosion inhibitor preferably comprises about 0.01% to 5% of the aerosol formulation.

Propellant

The foaming composition is delivered in the form of an aerosol. The propellant can comprise, for example, a hydrocarbon, of from 1 to 10 carbon atoms, such as methane, ethane, n-propane, n-butane, isobutane, n-pentane, isopentane, and mixtures thereof. The propellant may also be selected from halogenated hydrocarbons including, for example, fluorocarbons, chlorocarbons, chlorofluorocarbons, and mixtures thereof. (Besides of concerns about the destruction of the stratosphere's ozone layer, the use of fluorocarbons and chlorofluorocarbons is less preferred.) Examples of other suitable propellants are found in P. A. Sanders Handbook of Aerosol Technology (Van Nostrand Reinhold Co.) (1979) 2nd Ed., pgs. 348-353 and 364-367, which are incorporated by reference herein. Further, non-hydrocarbon propellants may be possible, such as carbon dioxide, nitrogen, compressed air, and, possibly, dense or supercritical fluids.

A liquefied gas propellant mixture comprising about 85% isobutane and 15% propane is preferred because it provides sufficient pressure to expel the cleaning composition from the container and provides good control over the nature of the spray upon discharge of the aerosol formulation. Preferably, the propellants comprises about 1% to 50%, more preferably about 2% to 25%, and most preferably about 5% to 15% of the aerosol formulation.

The aerosol formulation is preferably stored in and dispensed from a pressurized can that is equipped with a nozzle so that an aerosol of the formulation can be readily sprayed onto a surface. Dispensers are known in the art and are described, for example, in U.S. Pat. Nos. 4,780,100, 4,652,389, and 3,541,581 which are incorporated by reference herein. Although pressure within the dispenser, i.e., can pressure, does not appear to be critical, it may be preferred to range from about 10 to 100 psiq. at 70° F. (21.1° C.).

In loading the dispenser, the non-propellant components of the aerosol formulation are mixed into a concentrate and loaded into the dispenser first. Thereafter, the liquefied gaseous propellant is inserted before the dispenser is fitted with a nozzle.

Set of Instructions

It is important to advise the consumer that the treatment will provide a solution to problems involving and/or provision of a benefit related to those selected from the group consisting of: killing or reducing microbes; softening; reducing time and/or effort involved in cleaning carpets, reducing static; making the surface appear “fluffier”; and/or reduction in odors. It is important that the consumer be aware of these additional benefits, since otherwise the consumer would not know that the composition would solve these problems and/or provide these benefits. As used herein, the phrase “in association with” means the set of instructions are either directly printed on the reservoir itself or presented in a separate manner including, but not limited to, a brochure, print advertisement, electronic advertisement, and/or verbal communication, so as to communicate the set of instructions to a consumer of the article of manufacture. The set of instructions preferably comprises the instruction to apply an effective amount of the composition, preferably by spraying, to provide the indicated benefit, e.g. maintenance of carpet appearance, softness, and/or fluffy appearance; antimicrobial action; anti-static effect, and/or reduction in time and/or effort of cleaning and, optionally, the provision of odor control and/or reduction and reduction in microbial contamination and/or insects.

1. A cleaning system comprising:
a handle portion, the handle portion having a proximal end and a distal end; a cleaning head portion, the cleaning head portion adapted for use with a removable cleaning pad; and a cleaning fluid aerosol reservoir delivering cleaning fluid onto the surface to be cleaned adjacent the cleaning head portion.

2. The cleaning system of claim 1 wherein said aerosol reservoir comprises an aerosol container and a cradle therefore.

3. The cleaning system of claim 2 wherein said cradle is an integral extension of the handle, with the container and handle approximately being centered.

4. The cleaning system of claim 2 wherein the aerosol container is provided with a dispensing orifice.

5. The cleaning system of claim 4 wherein the aerosol dispenser is positioned such that the dispensing orifice dispenses cleaning fluid ahead of the cleaning head.

6. The cleaning system of claim 4 wherein the aerosol dispenser is position such that the dispensing orifice dispenses cleaning fluid behind the cleaning head.

7. The cleaning system of claim 2 wherein said cradle further comprises orienting means for orienting the aerosol container or a replacement therefore in a desirable position.

8. The cleaning system of claim 2 wherein said cradle further comprises locking means to stably lock the aerosol container into position.

9. The cleaning system of claim 1 wherein the handle portion has a length suitable for the user to actuate said cleaning system in an upright position.
